(19) United States
(12) Patent Application Publication
(10) Pub. No.: US 2026/0187550 A1
(43) Pub. Date: Jul. 2, 2026

(54) INFORMATION PROCESSING METHOD

(71) Applicant: TOYOTA JIDOSHA KABUSHIKI KAISHA, Toyota-shi (JP)

(72) Inventor: Keisuke MORISAKI, Toyota-shi (JP)

(73) Assignee: TOYOTA JIDOSHA KABUSHIKI KAISHA, Toyota-shi (JP)

(21) Appl. No.: 19/368,041

(22) Filed: Oct. 24, 2025

(30) Foreign Application Priority Data
Dec. 26, 2024 (JP) 2024-230769

(51) Int. Cl. G06Q 10/0631

(52) U.S. Cl. CPC G06Q 10/06311

(57) ABSTRACT

An information processing method includes estimating a congestion degree of a hydrogen station when a plurality of FCEV delivery vehicles receives refueling of hydrogen at the hydrogen station after an end of a delivery operation, by an information processing device, and changing, by the information processing device, a refueling timing of hydrogen for at least one of the FCEV delivery vehicles before the end of the delivery operation when a determination is made that the congestion degree is high.

### CROSS-REFERENCE TO RELATED APPLICATION

This application claims priority to Japanese Patent Application No. 2024-230769 filed on December 26, 2024. The disclosure of the above-identified application, including the specification, drawings, and claims, is incorporated by reference herein in its entirety.

### BACKGROUND

### 1. Technical Field

The present disclosure relates to an information processing method.

### 2. Description of Related Art

An information processing method including creating a plan for at least one of the most energy-efficient delivery route and the energy filling timing from vehicle-related information is disclosed (for example, see Japanese Unexamined Patent Application Publication No. 2024-55677 (JP 2024-55677 A)). The information processing method further includes instructing one or more vehicles to execute the plan.

### SUMMARY

There is a hydrogen station that refuels hydrogen into a fuel cell electric vehicle (FCEV) or the like (also referred to as a fuel cell vehicle (FCV)). In the hydrogen station, when the hydrogen refueling is performed continuously, there is a possibility that the pressure for refueling decreases. When the pressure decreases, since the time until the pressure is recovered is in a state of waiting for refueling, there is a problem that the time needed for refueling increases.

The present disclosure provides an information processing method capable of suppressing the occurrence of a vehicle waiting for pressure recovery in a hydrogen station.

An aspect of the present disclosure relates to an information processing method including:

estimating, by an information processing device, a congestion degree of a hydrogen station when a plurality of fuel cell electric vehicle (FCEV) delivery vehicles receives refueling of hydrogen at the hydrogen station after an end of a delivery operation; and

changing, by the information processing device, a refueling timing of hydrogen for at least one of the FCEV delivery vehicles before the end of the delivery operation when a determination is made that the congestion degree is high.

Other aspects of the present disclosure can include an information processing device, a computer program, a computer-readable temporary storage medium that stores the program, an information processing system, and the like.

According to the present disclosure, it is possible to suppress the occurrence of a vehicle waiting for pressure recovery in a hydrogen station.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration example of an information processing system according to an embodiment;

FIG. 2 is a diagram showing a configuration example of an information processing device;

FIG. 3 is a diagram showing a configuration example of the information processing device;

FIG. 4 is a flowchart showing processing example 1 of the information processing method;

FIG. 5 is a flowchart showing processing example 2 of the information processing method;

FIG. 6 is a flowchart showing processing example 3 of the information processing method; and

FIG. 7 is a flowchart showing processing example 4 of the information processing method.

### DETAILED DESCRIPTION OF EMBODIMENTS

An embodiment of the present disclosure will be described in detail with reference to the drawings. In the drawings, the same or similar portions are represented by the same reference numerals, and description thereof will not be repeated.

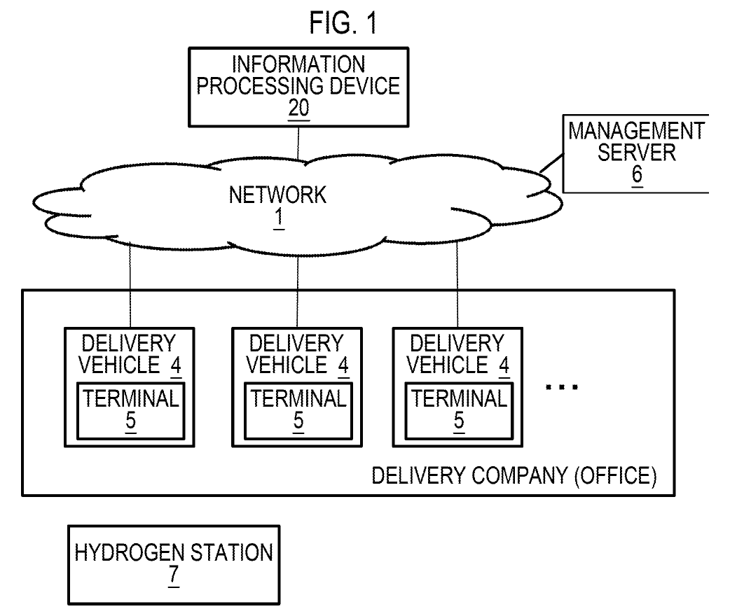

FIG. 1 is a diagram showing a configuration example of an information processing system according to the embodiment. In FIG. 1, a plurality of delivery vehicles 4 that deliver packages is present at an office of a delivery company. The delivery vehicles 4 are examples of FCEV delivery vehicles in the present disclosure. The delivery vehicle 4 is a fuel cell electric vehicle (FCEV), and is a vehicle (battery electric vehicle (EV)) that obtains a propulsion force by driving a motor with electric power generated by a fuel cell (FC).

For each delivery vehicle 4, for example, a delivery route is decided before delivery starts in a predetermined time unit (for example, a day). In addition, the delivery vehicle 4 goes to the hydrogen station 7 at a predetermined timing and receives the refueling of hydrogen. The timing of the refueling of hydrogen is decided whether to perform the refueling during delivery (before the end of the delivery operation) or to perform the refueling after the end of the delivery operation based on a drivable range that can be obtained from a hydrogen residual amount before delivery starts and a distance of a delivery route. For example, for the delivery vehicle 4 that has a residual amount sufficient to go to the hydrogen station 7 but has a residual amount that needs to be refueled after the end of the delivery operation, a refueling timing of hydrogen (reservation time of the hydrogen station 7) is decided after the end of the delivery operation. On the other hand, when there is a possibility that the residual amount of hydrogen is less than a certain amount during delivery, the refueling timing of hydrogen during delivery (time zone before the end of the delivery operation) is decided.

As shown in FIG. 1, as an example, the delivery vehicle 4 includes a terminal 5. The terminal 5 can communicate with a management server 6 or an information processing device 20 via the network 1 (Internet or the like). The terminal 5 may be a terminal attached to the delivery vehicle 4 (vehicle) or may be a portable terminal, such as a smartphone.

The management server 6 can collect information related to each delivery vehicle 4, such as a delivery route of the delivery vehicle 4 set in each terminal 5 and information indicating a residual amount of hydrogen of the delivery vehicle 4, by communicating with each terminal 5. The information processing device 20 acquires the information related to each delivery vehicle 4 by communicating with the management server 6, and decides the timing of refueling each delivery vehicle 4 by using the information. Note that the information processing device 20 may communicate directly with each terminal 5 to acquire information related to each delivery vehicle 4 from each terminal 5.

In addition, the information processing device 20 can calculate (estimate) the congestion degree of the hydrogen station for each predetermined time zone and determine whether the congestion degree is high from the timing of the refueling of each delivery vehicle 4. When determination is made that the congestion degree is high, the information processing device 20 adjusts (changes) the timing of refueling each delivery vehicle 4, and the start timing of charging is adjusted such that the refueling times arrive (are arranged) at sufficiently spaced intervals. As a result, it is possible to avoid the decrease in the pressure for refueling and the increase in the time needed for refueling by performing the continuous refueling of hydrogen at the hydrogen station 7. Therefore, it is possible to suppress the occurrence of a vehicle waiting for pressure recovery in a hydrogen station.

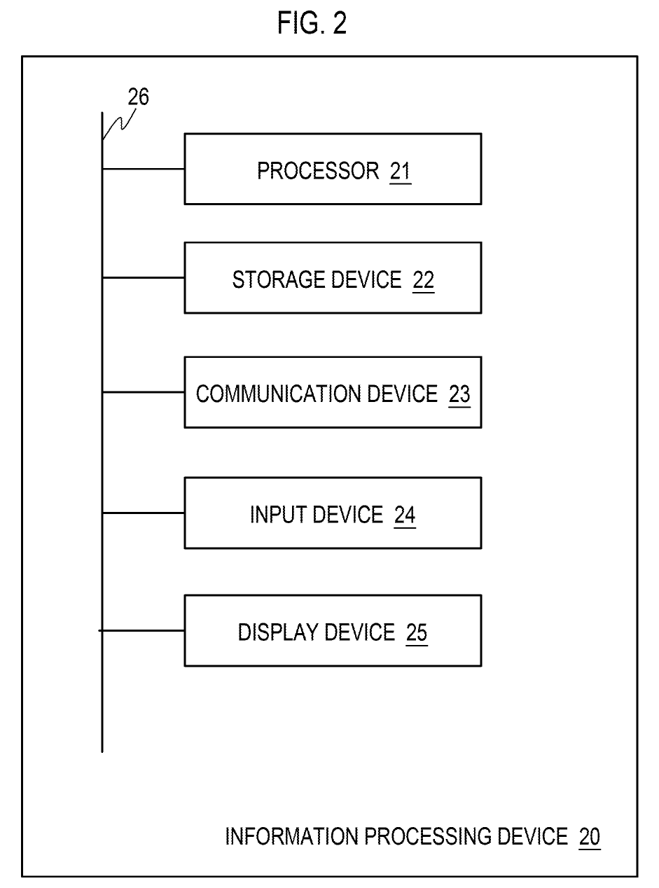

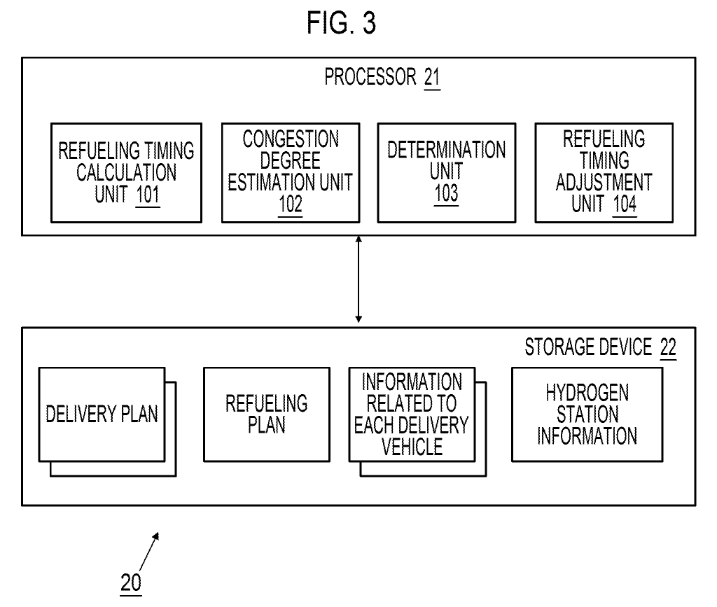

FIGS. 2 and 3 are diagrams showing a configuration example of the information processing device 20. The information processing device 20 is a dedicated or general-purpose computer, such as a personal computer (PC), a workstation (WS), or a server machine. In FIG. 2, the information processing device 20 includes a processor 21, a storage device 22, a communication device 23, an input device 24, and a display device 25 that are connected to each other via a bus 26. The processor 21 is a computing device that executes a program, such as a central processing unit (CPU). The storage device 22 includes a main storage device (memory) and an auxiliary storage device. The main storage device is used as a work area of the processor 21. The auxiliary storage device is used as a storage area for programs and data used by the processor 21. The communication device 23 is used to perform communication via the network 1 in accordance with a predetermined communication standard. The input device 24 is used for inputting data and information, and the display device 25 is used for displaying information. The input device 24 may be a physical button or switch, or may be a button or switch on a GUI displayed on a touch panel display that is the display device 25.

The information processing device 20 operates as follows shown in FIG. 3 by the processor 21 executing a program. That is, as shown in FIG. 3, the information processing device 20 operates as a device including a refueling timing calculation unit 101, a congestion degree estimation unit 102, a determination unit 103 for determining the congestion degree, and a refueling timing adjustment unit 104. The refueling timing calculation unit 101 is referred to as a "calculation unit 101" hereinafter. The congestion degree estimation unit 102 is referred to as an "estimation unit 102" hereinafter. The refueling timing adjustment unit 104 is referred to as an "adjustment unit 104" hereinafter.

The following information is stored in the storage device 22 by collecting (acquiring) or generating information. That is, the storage device 22 stores information related to each delivery vehicle 4 and information related to the hydrogen station 7 (hydrogen station information). The storage device 22 further stores information indicating a delivery plan (delivery route of each delivery vehicle 4) using the delivery vehicles 4 and information indicating a refueling plan of hydrogen for each delivery vehicle 4 (refueling timing of hydrogen for each delivery vehicle 4). The hydrogen station information can include, for example, statistical data of the congestion degree for each predetermined time zone. The statistical data of the congestion degree for each predetermined time zone is obtained from information indicating past usage performance of the hydrogen station 7 for the FCEV other than the delivery company (commercial user). The FCEV other than the delivery company (commercial user) is referred to as a vehicle of a general user or a general vehicle.

In addition, the information related to each delivery vehicle 4 (information indicating the delivery plan) can be acquired from two or more delivery companies, and the refueling plan of hydrogen for each delivery vehicle 4 of the two or more delivery companies can be generated (created) collectively (in a coordinated manner). However, the refueling plan of hydrogen can also be generated for each delivery company.

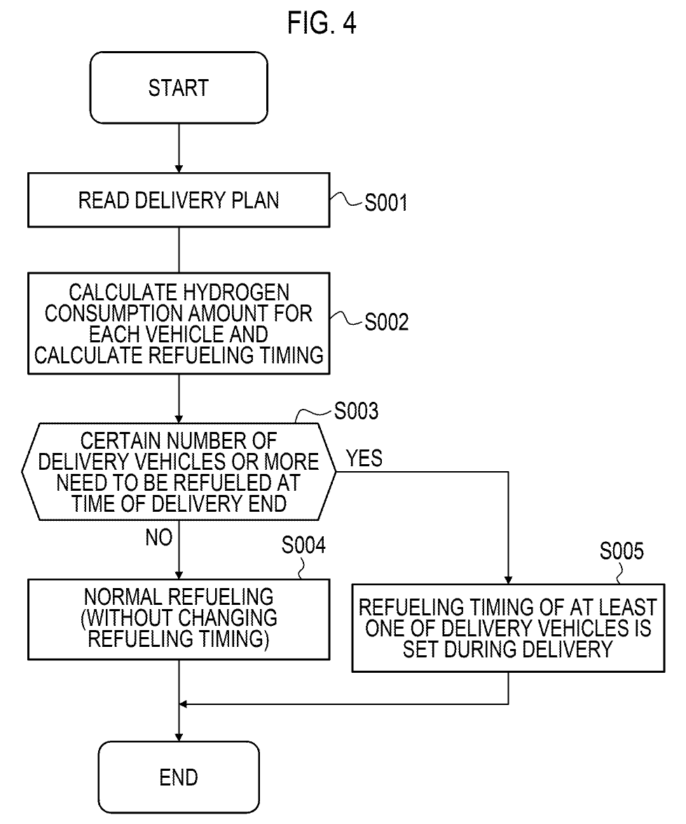

FIG. 4 is a flowchart showing an example of the information processing method by the information processing device 20 (processing example 1). In S001, the processor 21 of the information processing device 20 reads the delivery plan. In S002, the processor 21 operates as a calculation unit 101, calculates a hydrogen consumption amount for each vehicle (delivery vehicle 4) from information indicating the delivery plan (delivery route of each delivery vehicle 4), and calculates a refueling timing of hydrogen for each vehicle (delivery vehicle 4).

For example, the processor 21 decides the timing of refueling the hydrogen after the end of the delivery operation for the delivery vehicle 4 of which the residual amount of the hydrogen at the time of the end of the delivery operation is equal to or greater than a predetermined amount but is estimated to be insufficient in the next delivery operation. The next delivery operation is, for example, a delivery operation the next day. The term "after the end of the delivery operation" means after the end time of the delivery operation. For example, the refueling timing of hydrogen for the delivery vehicle 4 (refueling reservation) is set such that the delivery vehicle 4 that has completed the delivery operation and has returned to the office moves to the hydrogen station 7 (or stops by the hydrogen station 7 before returning to the office) to receive the refueling of the hydrogen. On the other hand, for the delivery vehicle 4 for which the determination is made that the hydrogen is insufficient until the end of the delivery operation, the processor 21 decides the refueling timing of the hydrogen during the delivery.

In S002, the processor 21 calculates the refueling timing of all the delivery vehicles 4 that perform the delivery operation.

In S003, the processor 21 treats the number of delivery vehicles 4 of which the refueling timing is set after the end of the delivery operation as information indicating the congestion degree. The congestion degree is an index indicating the congestion degree of the FCEVs waiting for refueling at the hydrogen station 7, and can be indicated in two stages of "low" or "high", for example, according to the number of the delivery vehicles 4. Note that the congestion degree may be indicated in three or more stages. The congestion degree may be estimated based on the delivery plan (delivery end time) of the FCEV delivery vehicles. For example, a state in which a number of the delivery end time of the delivery vehicles 4 to be refueled with hydrogen is equal to or greater than a certain number in a predetermined time zone may be defined as a state of high congestion degree, and a state other than the state may be defined as a state of low congestion degree. In addition, the congestion degree may be estimated based on the number of FCEV delivery vehicles of which the refueling timing of hydrogen is set after the end of the delivery operation. As described above, the processor 21 operates as an estimation unit 102 for estimating the congestion degree.

In S003, the processor 21 further operates as a determination unit 103 to determine whether equal to or greater than a certain number of delivery vehicles 4 need to be refueled at the time of delivery end (that is, whether the congestion degree is high). When determination is made that the number of delivery vehicles 4 of which the refueling timing of hydrogen is decided after the end of the delivery operation is equal to or greater than a certain number (high congestion degree), the process proceeds to S005, and when determination is not made, the process proceeds to S004.

In S004, normal refueling is performed. That is, the processor 21 generates a refueling plan in which refueling is performed at the refueling timing set at the time of the delivery plan for each delivery vehicle 4 without changing the refueling timing set for each delivery vehicle 4. Then, the processor 21 stores the refueling plan in the storage device 22. Generating the refueling plan is generating information indicating the refueling plan.

On the other hand, when the process proceeds to S005, the processor 21 operates as the adjustment unit 104. The processor 21 generates a refueling plan in which the refueling timing of at least one of the delivery vehicles 4 of which the refueling timing is set after the end of the delivery operation is changed to arrive during the delivery. The processor 21 stores the refueling plan in the storage device 22. The processor 21 refers to the hydrogen station information to change the refueling timing to a time zone during delivery when there is no vehicle in use or the number of vehicles in use is small. As the delivery vehicle 4 to be adjusted, for example, a configuration in which the delivery vehicle 4 is selected in order of a small residual amount of hydrogen (in order of a long refueling time), a configuration in which the delivery vehicle 4 is selected in order of a large residual amount of hydrogen, or a configuration in which the delivery vehicle 4 is randomly selected can be adopted.

In this way, when equal to or greater than a certain number of delivery vehicles 4 perform refueling at the hydrogen station 7 after the end of the delivery operation (high congestion degree), the refueling plan is generated such that the refueling timing is adjusted and the decrease in pressure due to continuous refueling is avoided.

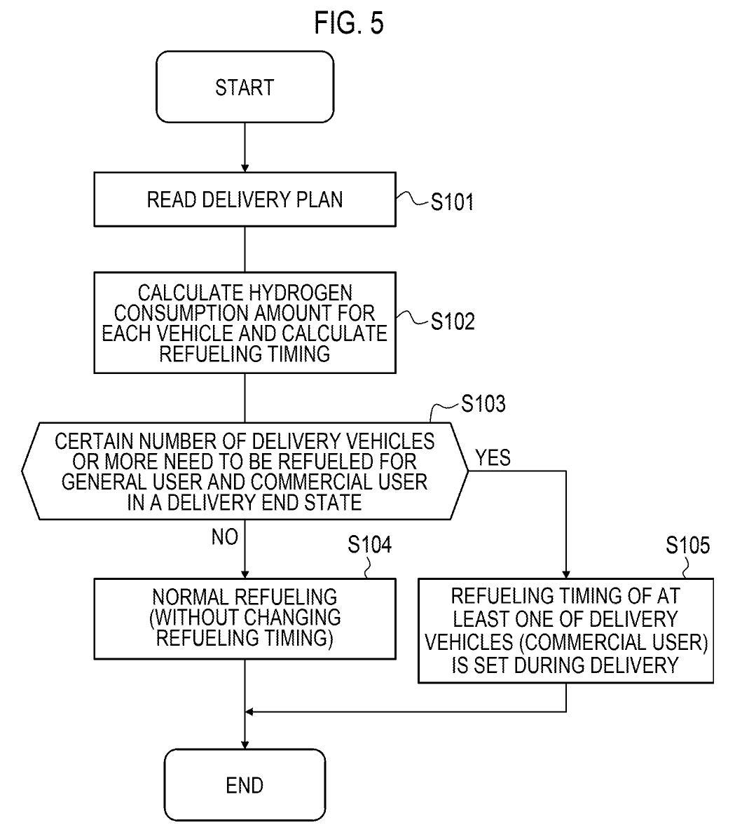

The information processing device 20 can execute the following processing example 2 instead of processing example 1. FIG. 5 is a flowchart showing an example of the information processing method by the information processing device 20. The flowchart showing an example of the information processing method by the information processing device 20 (processing example 2). Since the processing of S101 and S102 in FIG. 5 is the same as that of processing example 1 (S001 and S002), the description thereof will be omitted.

In S103, the processor 21 determines whether equal to or greater than a certain number of delivery vehicles 4 need to be refueled for a general user (general vehicle) and a commercial user (delivery vehicle 4) in a delivery end state. That is, the processor 21 reads out the estimated value of the number of general vehicles in the time zone after the end of the delivery operation. The estimated value of the number of general vehicles in the time zone after the end of the delivery operation is stored in the storage device 22 as hydrogen station information. The processor 21 adds the estimated value of the number of general vehicles to the number of delivery vehicles 4 of which the refueling timing is set after the end of the delivery operation. The processor 21 determines whether the addition value is equal to or greater than a certain number of delivery vehicles 4 (the congestion degree is high). When determination is made that the addition value is equal to or greater than a certain number of delivery vehicles 4, the process proceeds to S105, and when determination is not made, the process proceeds to S104.

In S104, normal refueling, that is, refueling is performed at each refueling timing without changing the refueling timing set for the general vehicle and each delivery vehicle 4. On the other hand, when the process proceeds to S105, the processor 21 changes, during the delivery, at least one of the refueling timings of the commercial users (delivery vehicles 4) set after the end of the delivery operation for the commercial user (delivery vehicle 4). The processing of S105 is the same as the processing of S005.

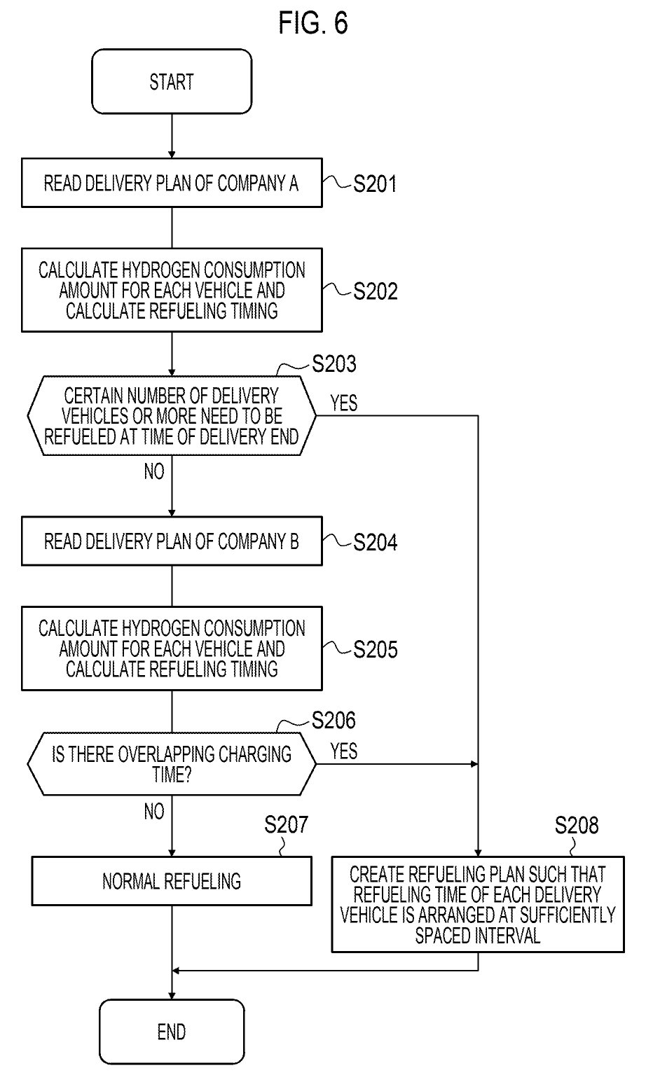

The information processing device 20 can execute the following processing example 3 instead of processing examples 1 and 2. FIG. 6 is a flowchart showing an example of the information processing method by the information processing device 20 (processing example 3). In processing example 3, a processing example when the information indicating the delivery plan of two delivery companies (company A and company B) is acquired by the information processing device 20 is shown.

S201 to S203 are the same processing as S001 to S003 (FIG. 4) performed for the delivery plan of company A. In S203, when determination is made as YES, the process proceeds to S208, and when determination is not made as YES, the process proceeds to S204.

S204 and S205 are the same processing as S001 and S002 (FIG. 4) performed for the delivery plan of company B. In S206, the processor 21 determines whether there is an overlapping charging time (= the congestion degree is high) for the charging time of each delivery vehicle.

When determination is made as YES in S206, the process proceeds to S208, and when determination is not made as YES, the process proceeds to S207. Note that the processing of S201 to S203 may be performed for company B, and the processing of S204 to S206 may be performed for company A.

In S207, the processor 21 decides to perform normal refueling. That is, the processor 21 does not change the refueling timing set for each delivery vehicle 4 owned by company A and company B. The processor 21 generates (generates information indicating the refueling plan) a refueling plan in which refueling is performed at the refueling timing set at the time of the delivery plan for each delivery vehicle 4, and stores the refueling plan in the storage device 22. The refueling plan may be generated as a refueling plan of the delivery vehicle 4 owned by company A and a refueling plan of the delivery vehicle 4 owned by company B, or may be generated as a refueling plan obtained by integrating the refueling plans.

In S208, the processor 21 create (generates information indicating the refueling plan) a refueling plan such that the refueling times of each delivery vehicle 4 is arranged at a sufficiently spaced interval. For example, the processor 21 changes the refueling timing as follows in a state where the refueling plan of any one of the company A and company B is not changed. The processor 21 changes the refueling timing such that the refueling is performed in a state where the charging time does not overlap with the empty time at the hydrogen station 7 for each of the delivery vehicles 4 of the other one of company A and company B. The state in which the charging time is not overlapped is a state in which a sufficient interval (interval) is provided between the charging times. Alternatively, the refueling plan may be generated such that the refueling is performed after the delivery ends for the delivery vehicle 4 of one of company A and company B, and the refueling is performed during the delivery for the delivery vehicle 4 of the other of company A and company B. According to processing example 3, when a plurality of (two or more) delivery companies uses a common hydrogen station, it is possible to suppress the occurrence of a time when the charging time of the delivery vehicle 4 overlaps with the hydrogen station 7 (a state of high congestion degree). As a result, it is possible to avoid the decrease in the pressure of the refueling due to the continuous refueling.

Processing example 3 shown in FIG. 5 shows processing in the information processing device 20. The information processing device 20 may perform the processing of S001 to S003 for one of company A and company B, and an information processing device other than the information processing device 20 may perform the processing of S001 to S003 for the other of company A and company B. The information processing device other than the information processing device 20 is, for example, the management server 6. The information processing device 20 may execute the processing of S208 when the determination of YES is made in at least one of S003.

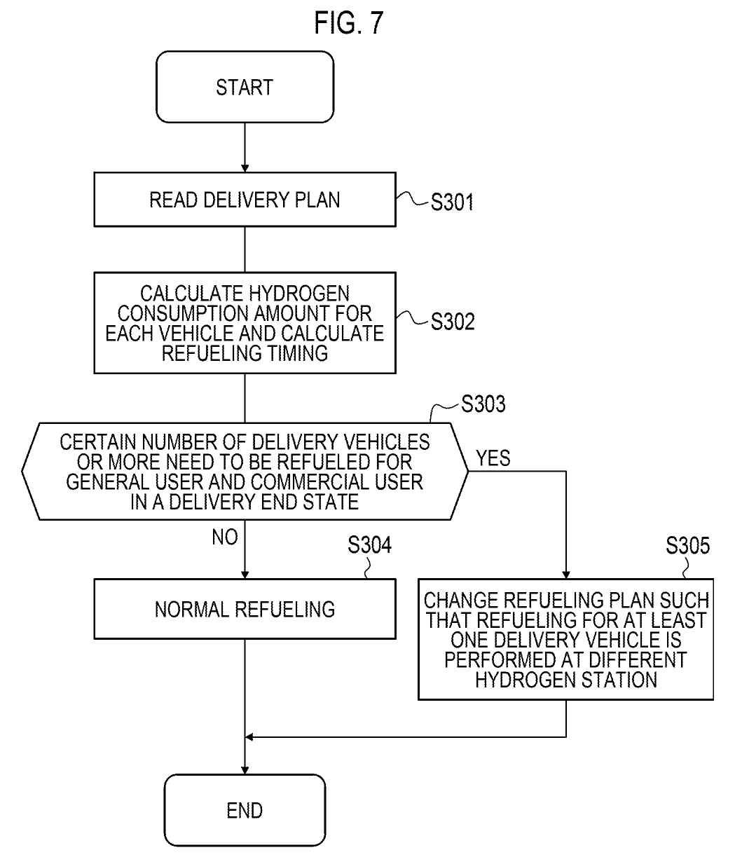

The information processing device 20 can execute the following processing example 4 instead of processing examples 1 to 3. FIG. 7 is a flowchart showing an example of the information processing method by the information processing device 20 (processing example 4).

Since the processing of S301 to S304 shown in FIG. 7 is the same as the processing of S101 to S104 shown in FIG. 5, the description thereof will be omitted. In S305, the processor 21 changes the refueling plan such that the refueling of hydrogen for at least one delivery vehicle 4 is performed at a hydrogen station other than the hydrogen station 7 (referred to as a hydrogen station 7A). For example, the information related to the hydrogen station 7A is stored in the storage device 22 as the hydrogen station information. The processor 21 decides the refueling timing for at least one delivery vehicle 4 such that at least one of the delivery vehicles 4 to be refueled is selected and the refueling for the selected delivery vehicle 4 is performed during the empty time of the hydrogen station 7A.

According to processing example 4, it is possible to avoid the decrease in pressure due to continuous refueling at the hydrogen station 7 by performing the adjustment of performing the refueling of at least one delivery vehicle 4 at the hydrogen station 7A.

According to the information processing method according to the embodiment, the information processing device 20 (processor 21) operates as the estimation unit 102 (S003, S103, S203, S303). The estimation unit 102 estimates the congestion degree of the hydrogen station 7 when the refueling of the hydrogen is received by the delivery vehicles 4 (FCEV delivery vehicles) at the hydrogen station 7 after the end of the delivery operation. In addition, the information processing device 20 (processor 21) operates as the adjustment unit 104 (S008, S108, S208). The adjustment unit 104 changes the refueling timing of hydrogen for at least one of the delivery vehicles 4 before the end of the delivery operation when the determination is made by the determination unit 103 that the congestion degree is high (equal to or greater than a certain number of delivery vehicles 4). That is, it is possible to avoid the decrease in pressure due to continuous refueling at the hydrogen station 7. Therefore, it is possible to suppress the occurrence of a vehicle (FCEV) waiting for pressure recovery in the hydrogen station 7.

The congestion degree can be estimated based on the delivery plan of the delivery vehicles 4 (delivery end time or the like). In addition, the congestion degree may be estimated based on the number of delivery vehicles 4 scheduled to receive the refueling of the hydrogen (the refueling timing is decided after the end of the delivery operation) after the end of the delivery operation.

In addition, as shown in processing example 3 in the embodiment, the refueling of the delivery vehicles 4 can be planned as follows. That is, when each of the delivery vehicles 4 belongs to two or more delivery companies (company A and company B), it is possible to plan the refueling of the delivery vehicles 4 such that the charging time of each of the delivery vehicles 4 is arranged at an interval. That is, when the delivery vehicles that perform the delivery in the delivery plan of two or more delivery companies are the FCEV delivery vehicles, it is possible to plan the refueling of the delivery vehicles such that the refueling times of each of the delivery vehicles is arranged at an interval.

In addition, as shown in processing example 5 (FIG. 7) in the embodiment, the following decision may be made when determination is made that the congestion degree is high. That is, instead of setting the refueling timing of hydrogen for at least one of the delivery vehicles 4 before the end of the delivery operation, a decision may be made that at least one of the delivery vehicles 4 is to receive the refueling of hydrogen at the hydrogen station 7A different from the hydrogen station 7. The hydrogen station 7 is a first hydrogen station. The hydrogen station 7A is a second hydrogen station.

As shown in the embodiment, the information processing device 20 (processor 21) may determine whether the refueling of hydrogen during delivery is needed for each delivery vehicle 4 that performs the delivery, based on the hydrogen residual amount before the delivery start and the hydrogen consumption amount obtained from the delivery route. The information processing device 20 (processor 21) may decide the refueling timing of hydrogen during delivery when determination is made that the refueling of the hydrogen during delivery is needed. The information processing device 20 (processor 21) may decide the refueling timing of the hydrogen after the delivery end when determination is made that the refueling of the hydrogen during the delivery is not needed. The processing (processing examples 1 to 4) executed by the information processing device 20 may be executed by one terminal 5 of the terminals 5 or in cooperation with two or more of the terminals 5. The configuration shown in the embodiment can be appropriately combined as long as the object of the disclosure can be achieved.

Further, the processing and means described in the present disclosure can be implemented in any combination as long as no technical inconsistencies arise. The processing described as being performed by one device may be executed by a plurality of devices in a shared manner. Alternatively, the processing described as being performed by different devices may be executed by one device. In a computer system, a hardware configuration (server configuration) for realizing each function can be flexibly changed.

The present disclosure can also be realized by supplying a computer program in which the functions described in the above embodiment are implemented to a computer, and reading and executing the program by one or more processors possessed by the computer. Such a computer program may be provided to the computer by a non-temporary computer-readable storage medium that can be connected to the computer's system bus, or may be provided to the computer via a network. The non-temporary computer-readable storage medium includes, for example, any type of disk, such as a magnetic disk (Floppy (Registered trademark) disk, hard disk drive (HDD), or the like), or an optical disk (CD-ROM, DVD disk, blu-ray disk, or the like). The non-temporary computer-readable storage medium includes, for example, any type of medium suitable for storing electronic instructions. Any type of medium suitable for storing electronic instructions includes a read-only memory (ROM), a random access memory (RAM), EPROM, EEPROM, a magnetic card, a flash memory, or an optical card.

What is claimed is:

1. An information processing method comprising:
estimating, by an information processing device, a congestion degree of a hydrogen station when a plurality of fuel cell electric vehicle (FCEV) delivery vehicles receives refueling of hydrogen at the hydrogen station after an end of a delivery operation; and
changing, by the information processing device, a refueling timing of hydrogen for at least one of the FCEV delivery vehicles before the end of the delivery operation when a determination is made that the congestion degree is high.

2. The information processing method according to claim 1, wherein the congestion degree is estimated based on a delivery plan of the FCEV delivery vehicles.

3. The information processing method according to claim 1, wherein the congestion degree is estimated based on the number of the FCEV delivery vehicles scheduled to receive the refueling of hydrogen after the end of the delivery operation.

4. The information processing method according to claim 1, wherein, when the FCEV delivery vehicles are a plurality of delivery vehicles that performs delivery in delivery plans of two or more delivery companies, refueling of the delivery vehicles is planned such that refueling times of each of the delivery vehicles are arranged at an interval.

5. The information processing method according to claim 1, wherein, when a determination is made that the congestion degree is high, instead of changing the refueling timing of hydrogen for at least one of the FCEV delivery vehicles before the end of the delivery operation, a decision is made that at least one of the FCEV delivery vehicles is to receive the refueling of hydrogen at a second hydrogen station different from a first hydrogen station that is the hydrogen station.

6. The information processing method according to claim 1, further comprising determining, for each of the FCEV delivery vehicles that perform the delivery, whether refueling of hydrogen during delivery is needed based on a hydrogen residual amount before delivery start and a hydrogen consumption amount obtained from a delivery route, deciding a refueling timing of the hydrogen during the delivery when a determination is made that the refueling of the hydrogen during the delivery is needed, and deciding a refueling timing of the hydrogen after delivery end when a determination is made that the refueling of the hydrogen during the delivery is not needed.
